(19) United States
(12) Patent Application Publication
(10) Pub. No.: US 2007/0150536 A1
(43) Pub. Date: Jun. 28, 2007

(54) Peripheral device having user preference history and method of operation

(75) Inventors: Mohamed N. Ahmed, Louisville, KY (US); Brian E. Cooper, Lexington, KY (US); Michael E. Lhamon, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(73) Assignee: Lexmark International, Inc.

(21) Appl. No.: 11/318,683

(22) Filed: Dec. 27, 2005

(51) Int. Cl. G06F 15/16

(52) U.S. Cl. 709/203

(57) ABSTRACT

A peripheral device includes a processor adapted to generate a list, the list including at least one job previously performed by the device, a user interface in communication with the processor and adapted to display the list and a storage medium in communication with the processor and adapted to store the list, wherein, when the device performs a new job, the processor updates the list to include the new job.

### BACKGROUND

This disclosure relates to peripheral devices and, more particularly, to systems and methods for setting and/or selecting various parameters on a peripheral device.

Peripheral devices, such as all-in-one print devices (AlOs), multi-function peripherals (MFPs), printers, scanners, facsimile machines and the like, have become commonplace in the home and office environment and may be used to perform a wide variety of tasks. As used herein, “peripheral device” refers to a stand-alone device or a device connected to a computer, a host, a network, a server or the like.

MFPs typically provide printing, copying, scanning and/or facsimile capabilities in a single device. Typically, MFPs incorporate two basic components: a scanner component and a print engine. The scanner may convert physical documents and images into electronic data, and the print engine may convert electronic data into physical documents or images. Printing and scanning may be performed on an MFP utilizing just one component of the device (i.e., the scanner for scanning or the print engine for printing), while copying may be performed utilizing both components (i.e., the scanner may scan the document and the print engine may generate copies based upon the scanned data).

Peripheral devices, such as MFPs, typically include various user-selectable parameters. The selectable parameters may include color, contrast, darkness, number of copies, scale factor, output format (e.g., PDF and JPEG), input format (e.g., size, orientation and one or two-sided), destination email address, destination facsimile number or the like. The print device may set the parameters to various default values. Alternatively, a user may customize one or more parameters prior to initiating a job.

Customizing the parameters typically requires the manipulation of several menu options. Therefore, repeating a job may require a user to remember and select the same parameters, which may be inconvenient, tedious and time consuming.

Accordingly, there is a need for a system and method for quickly and easily selecting and setting various parameters on a print device.

### SUMMARY OF THE INVENTION

In one aspect, a peripheral device may include a processor adapted to generate a list, the list including at least one job previously performed by the device, a user interface in communication with the processor and adapted to display the list and a storage medium in communication with the processor and adapted to store the list such that when the device performs a new job, the processor updates the list to include the new job.

In another aspect, a method for setting operating parameters for a new job on a peripheral device may include generating a list of jobs previously performed by the device, wherein each of the previously performed jobs includes at least one set parameter, updating the list when the device performs a job and displaying the list on a user interface.

In another aspect, a method for setting operating parameters for a new job on a peripheral device is provided and may include setting at least one parameter on the device, performing a first job based upon the set parameter, storing the first job in a storage medium and, prior to performing the new job, displaying the first job on a user interface.

Other aspects will become apparent from the following description, the accompanying drawings and the appended claims.

### BRIEF DESCRIPTION OF THE DRAWINGS

FIG. 1 is a block diagram of an MFP according to one aspect of the disclosed system and method;

FIG. 2 is a block diagram of the MFP of FIG. 1 in communication with a server; and

FIG. 3 is a block diagram of the user interface of the MFP of FIG. 1.

### DETAILED DESCRIPTION

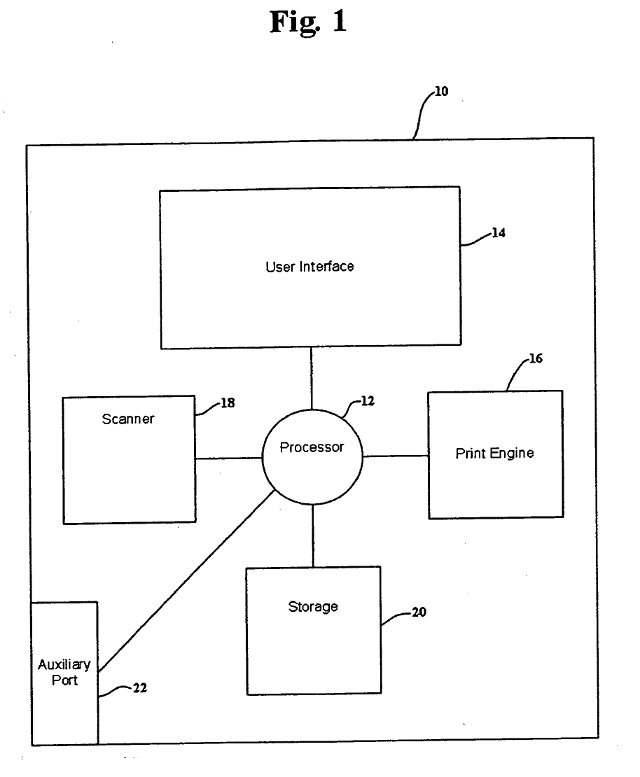

As shown in FIG. 1, a peripheral device, generally designated 10, may be a multifunction peripheral (MFP) or an all-in-one (AIO) device and may include a processor 12 in communication with a user interface 14, a print engine 16 and a scanning subsystem or scanner 18. Additionally, the device 10 may include a storage medium 20 and/or an auxiliary port 22. The auxiliary port 22 may be a USB port, a serial port, a parallel port, disk drive or the like.

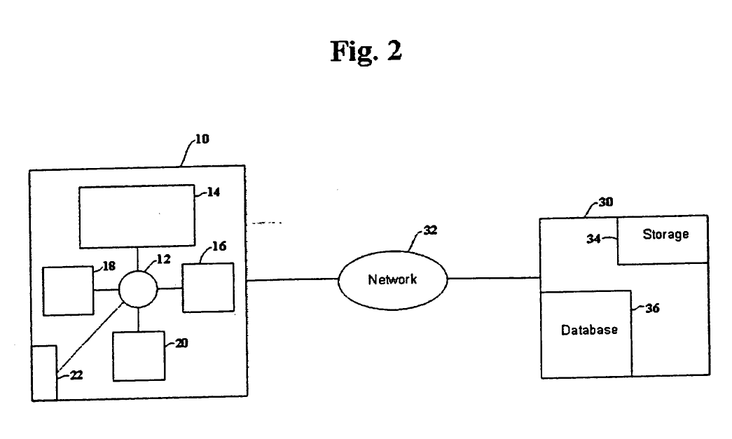

As shown in FIG. 2, the device 10 may be in communication with a server 30 over a network 32. The server 30 may include a storage medium 34 and a user authentication database 36. The network 32 may be any available network, such as a local area network, a wide area network, the internet, an intranet or the like.

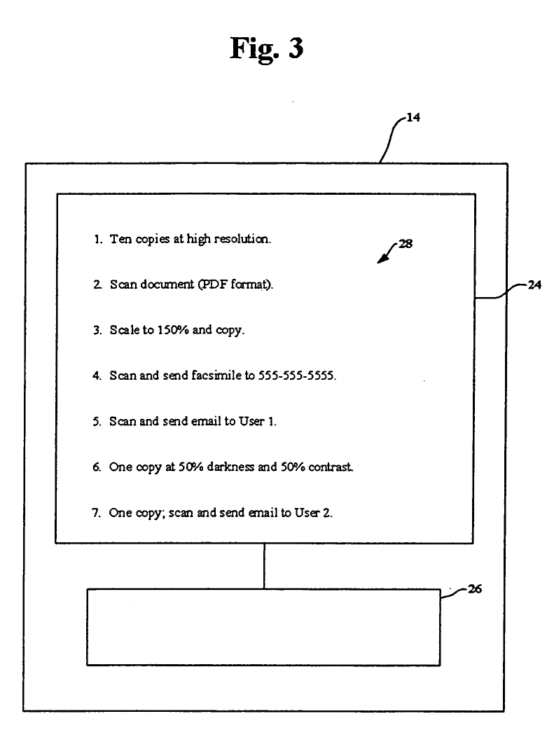

As shown in FIG. 3, the user interface 14 may include a graphical display or screen 24 and a user input portion 26. The screen 24 may be a monitor, a video screen, an LCD display or the like. The screen 24 may be capable of displaying various images, menus, text or other indicia, such as a list of recently performed jobs 28, as described in greater detail below. The input portion 26 may be a keyboard, a touch panel, various buttons, a mouse or the like. The input portion 26 may allow a user to select, navigate and/or manipulate the images, menus, text or other indicia displayed on the screen 24. In one aspect, the user interface 14 may include a touch-sensitive display screen. In another aspect, the user interface 14 may provide vocal communication (e.g., by way of a speaker or the like) between the device 10 and the user. In 20 another aspect, the user interface 14 may provide vocal and visual communication between the device 10 and the user.

The user interface 14 may provide the user with a way to communicate with the processor 12 (FIG. 1) and various subsystems (e.g., print engine 16 and/or scanner 18) of the device 10 such that a user may view (or be advised of), select and/or set various parameters prior to initiating a job. The term “job” as used herein refers to any function of the device 10, including, without limitation, printing, copying, receiving or transmitting facsimiles or other electronic data, and scanning or storing/retrieving a document, image or data locally or over a network. The parameters may be any aspect of the job, including without limitation data, settings, locations or inputs related to the operation or output of the device 10 and may include, for example, color, contrast, darkness, number of copies, scale factor, output format, input format, destination email address and destination facsimile number.

Accordingly, prior to initiating a job, a user may select and set various parameters as desired. The parameters not customized may be left at the default settings. Once the desired parameters are set, the user may initiate the job, and the device 10 may perform the job according to the set parameters.

In one aspect, the parameter settings of previous jobs may be stored such that they may be recalled prior to initiating subsequent jobs, thereby allowing a user to select a previously used parameter setting quickly and easily. In one aspect, the previously used parameter settings may be stored in the storage medium 20 of the device 10. In another aspect, the previously used parameter settings may be stored in the storage medium 34 of the server 30. In another aspect, the previously used parameter settings may be stored on various devices (not shown) that are connectable to the auxiliary port 22, such as a memory disk, a USB memory stick or the like.

In one aspect, the device 10 may display a list of previously performed jobs 28, including the previously used parameter settings, by way of the user interface 14, as shown in FIG. 3, such that the user may reuse previously used parameter settings. Those skilled in the art will appreciate that the list 28 may be in the form of a table, icons, blocks, a chart, a menu or the like. Each previously completed job in the list 28 may have specific parameter settings, thereby allowing a user to quickly and easily perform jobs using past parameter settings without the need for remembering, selecting and/or setting each parameter.

In one aspect, the list 28 may include a list of all previously performed jobs. In another aspect, the list 28 may include the last N number of jobs (e.g., N=about 1 to about 20). The jobs may be listed by date, wherein the most recent job is at the top of the list. For example, the parameter settings of the last 7 jobs are displayed in FIG. 3. In another aspect, a user may designate certain previously performed jobs as “permanent” or “do not delete” such that they always appear in the list 28. In another aspect, the list 28 may include a filtered set of jobs. For example, the list 28 may not include duplicate jobs (i.e., duplicate jobs may be filtered from the list). In another aspect, the list 28 may include a list of jobs performed within a specific time frame. For example, the list 28 may include all jobs performed within the past seven days.

In one aspect, the list 28 may be compiled for a specific user or a group of users (e.g., administrators). For example, each user of the device 10 (FIG. 2) may have a personal USB memory stick (not shown) for storing the parameter settings of previous jobs. Alternatively, the device 10 may perform user authentication, wherein a list 28 specific to the authenticated user or group of users is recalled and displayed on the user interface 14. In one aspect, the following steps the user may enter a username and/or a password at the device 10; the device 10 may communicate the username and/or password to the server 30; the server 30 may compare the entered username and/or password against data stored in the user authentication database 36; and once the user is authenticated, the server 30 may recall the previous parameter settings specific to the authenticated user, and the previous parameter settings may be displayed on the user interface 14 of the device 10. Alternatively, the user may be authenticated using a radio frequency identification (RFID) card, a physical key or a biometric interface, such as a fingerprint scan, a signature scan, a retinal scan, face recognition, voice pattern matching or the like.

In another aspect, the list 28 may include previous parameter settings for all users of the device 10.

Accordingly, when a user begins a new job on the device 10, the device 10 may display data pertaining to previous parameter settings, such as the list 28 shown in FIG. 3. The user may select a job or other item from the list 28 and perform the new job according to the parameters of the selected job (i.e., the parameters of the selected job will be repeated for the new job). In one aspect, the user may further customize the parameters for the new job by changing at least one or all of the parameters of the selected job.

Although various aspects of the subject peripheral device have been shown and described, it should be understood that they have been presented by the way of example only, and not limitation. It will be understood by those skilled in the art that various changes in form and details may be made therein without departing from the spirit and scope of the invention as defined. Thus, the breadth and scope of the present invention should not be limited by any of the above-described exemplary aspects.

The public is hereby placed on notice that any patent that may issue on this application includes such modifications and is limited only by the scope of the claims.

What is claimed is:

1. A peripheral device, comprising:
a processor adapted to generate a list, said list including at least one parameter setting of at least one job previously performed by said device;
a user interface in communication with said processor and adapted to communicate said list to a user; and
a storage medium in communication with said processor and adapted to store said list, whereby said processor updates said list to include at least one parameter setting of a new job performed by said device.

2. The peripheral device of claim 1, further comprising at least one of a print engine and a scanning subsystem.

3. The peripheral device of claim 1, wherein said list includes at least one parameter setting of a plurality of jobs previously performed by said device.

4. The peripheral device of claim 3, wherein said parameter setting is selected from the group consisting of color, contrast, darkness, number of copies, scale factor, output format, input format, destination email address and destination facsimile number.

5. The peripheral device of claim 1, wherein said previously performed job includes at least one of a copy job, a scan job, a print job and a facsimile job.

6. The peripheral device of claim 1, wherein said user interface communicates said list to said user by at least one of a visual method and a vocal method.

7. The peripheral device of claim 1, wherein said previously performed job is a recently completed job.

8. The peripheral device of claim 1, wherein said user interface includes a screen and a user input portion.

9. The peripheral device of claim 1, wherein said user interface includes a touch-sensitive display screen.

10. The peripheral device of claim 1, wherein said user interface is adapted to facilitate user selection of at least one of said parameter settings.

11. The peripheral device of claim 1, wherein said processor is in communication with said storage medium over a network.

12. The peripheral device of claim 1, further comprising wherein said storage medium is in communication with said processor by way of an auxiliary port.

13. The peripheral device of claim 12, wherein said storage medium is selected from the group consisting of a memory disk, a memory card and a USB memory stick.

14. The peripheral device of claim 1, wherein each of said parameter settings of said previously performed jobs and said parameter settings of said new job correspond to at least one of a specific user and a group of users.

15. A method for operating a peripheral device, comprising:
communicating a list of at least one jobs previously performed by said device, wherein said communicated list includes at least one parameter setting of at least one previously performed one of said jobs;
when said device performs a new job, updating said list with information relating thereto; and
communicating said updated list by way of a user interface.

16. The method of claim 15, further comprising selecting a previously performed job from said list and performing said new job using said print device based at least upon said parameter setting of said selected job.

17. The method of claim 15, further comprising storing said list in a storage medium.

18. The method of claim 15, further comprising authenticating a user prior to displaying said list.

19. The method of claim 15, wherein at least one of said communicating is performed by at least one of a visual method and a vocal method.

20. A method for setting operating parameters for a new job on a peripheral device having a user interface, comprising:
setting at least one parameter on said device;
performing a first job based at least upon said parameter;
storing information pertaining to said parameter in a storage medium; and
prior to performing said new job, communicating said information by way of said user interface.
